(19) United States
(12) Patent Application Publication
(10) Pub. No.: US 2006/0041920 A1
(43) Pub. Date: Feb. 23, 2006

(54) Method and system for transparent addition of features to network devices

(75) Inventor: John W. Chaney, Gilroy, CA (US)

Correspondence Address: MYERS DAWES ANDRAS & SHERMAN, LLP, 19900 MACARTHUR BLVD.,, SUITE 1150, IRVINE, CA, 92612, US

(73) Assignee: Samsung Electronics Co., Ltd., Suwon City (KR)

(21) Appl. No.: 10/921,693

(22) Filed: Aug. 19, 2004

(51) Int. Cl. H04N 7/173; H04N 7/16

(52) U.S. Cl. 725/117; 725/100; 725/131; 725/116; 725/146; 725/147

(57) ABSTRACT

A method of incrementally adding functions to a network that has a source device and a sink device, where the source device provides signals to the sink device. Accordingly, the type of the source signal from the source device is determined. It is then determined if the sink device is capable of properly utilizing the source signal. If the sink device is not capable of utilizing the source signal, then a function is provided in the network which enables the sink device to properly utilize the source signal.

### FIELD OF THE INVENTION

The present invention relates to transparent addition of features to audio/video devices and in particular to transparent addition of features to HDTVs using home networking techniques.

### BACKGROUND OF THE INVENTION

A network generally includes a communication link and various devices with communication capability connected to the communication link. The devices include computers, peripheral devices, routers, storage devices, consumer electronics and appliances with processors and communication interfaces. An example of a network is a home network for a household in which various devices are interconnected. A usual household can contain several devices including personal computers and home devices such as consumer electronics and appliances that are typically found in the home. As such the term “device” generally includes logical devices or other units having functionality and an ability to exchange data, and can include not only all home devices but also general purpose computers.

Home devices include such electronic devices as security systems, theater equipment, consumer electronics (e.g., HDTVs, VCRs, DVD players, stereo equipment, direct broadcast satellite services (DBSS), digital satellite services (DSS), etc.), and the like. For example, such home devices can include support for networking using e.g. 1394 standard and communication protocols such as HTTP and HTML standards for inter-device communication and operation.

In one example home network (FIG. 1), a sink device such as a high definition TV (HDTV) 12 is connected to a source device such as DSS 14 which provides digital programming to the HDTV via an IEEE-1394 network. The network includes a decoder 16 in a set top box (STB) that decodes the signals from the DSS for the HDTV. However, each decoder 16 is designed to decode a certain format and as a result such a network 10 is inflexible in decoding new signal formats from the DSS 14. For example, if the decoder 16 is designed for decoding MPEG2 format and the DSS 14 beings to provide MPEG4 format signal, then the MPEG2 decoder 16 must be replaced with a new decoder that also provides MPEG4 decoding. This increases costs and complexity.

There is, therefore, a need for a system and method for transparent and economical addition of features to devices in networks.

### BRIEF SUMMARY OF THE INVENTION

The present invention addresses the above needs. In one embodiment the present invention provided a method of incrementally adding functions to a network including a source device and a sink device, wherein the source device provides signals to the sink device. The method comprises the steps of: determining the type of a source signal from the source device; determining if the sink device is capable of properly utilizing the source signal; and if the sink device is not capable of utilizing the source signal, then providing a function in the network which enables the sink device to properly utilize the source signal. The method further includes the steps of switching the sink device to utilize said function.

The step of providing said function in the network can further include the steps of providing a processing device in the network that enables the sink device to properly utilize the source signal. In one example, the source device provides encoded signals to the sink device, wherein determining the type of the source signal further includes the steps of determining the type of encoding of the source signal; determining if the sink device is capable of utilizing the source signal further includes the steps of determining if the sink device can decode the source signal; and providing said function in the network further includes the steps of providing a decoder in the network for decoding the source signal for the sink device. In that case, the source device is switched to utilize the signal decoded by the decoder.

In another aspect, the present invention provides a controller that implements the above steps in a network.

Other embodiments, features and advantages of the present invention will be apparent from the following specification taken in conjunction with the following drawings.

### BRIEF DESCRIPTION OF THE DRAWINGS

FIG. 1 shows an example functional block diagram of a conventional network.

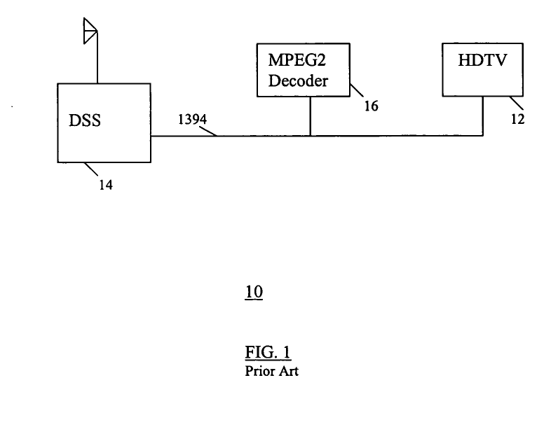

FIG. 2 shows an example function block diagram of an embodiment of a network according to the present invention which allows incremental addition of functions.

FIG. 3 shows an example function block diagram of another embodiment of a network according to the present invention which allows incremental addition of functions.

FIG. 4 shows an example function block diagram of another embodiment of a network according to the present invention which allows incremental addition of functions, illustrating an example connectivity diagram for an NIU device, MPEG4 decoder device and HDTV device.

FIG. 5 shows an example flowchart of the example steps of the operation of the network in FIG. 4, according to an embodiment of the present invention.

### DETAILED DESCRIPTION OF THE INVENTION

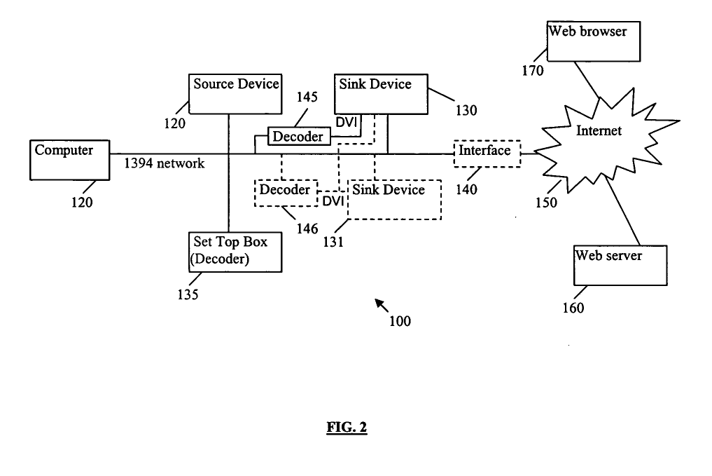

FIG. 2 shows an example functional architecture of a network 100, such as a home network, that implements an embodiment of the present invention. The network 100 comprises source devices 120 (e.g., DSS), sink devices 130 (e.g., HDTV), and optional interface 140 that connects the network 10 to the Internet 150, the web server 160 and the web browser 170.

The network 100 further includes a decoder 135 that decodes signals from a source device 120 for a sink device 130. The sink and source devices can implement a client-server protocol, using e.g. HTTP protocol and XHTML (Extended HTML) for communication therebetween. For example, an HDTV 130 can include a Web browser and a DSS 120 can include a Web server. In one example, the sink and source devices can communicate via the TCP/IP network protocol in a 1394 network.

According to an embodiment of the present invention, the network 100 further allows addition of a second decoder 145 to decode other signals from one or more of the source devices 120 for a sink device 130. For example, if the decoder. 135 is designed for decoding MPEG2 format signals and a DSS 120 begins to provide MPEG4 format signals, then the decoder 145 which is capable of MPEG4 format signals can be added to the network 100, rather than replacing the decoder 135 with another decoder that also provides MPEG4 decoding.

Then, when the DSS 120 provides MPEG2 encoded signals, the decoder 135 is used to decode the MPEG2 signals for the sink 130, and when the DSS 120 also provides MPEG4 encoded signals, the decoder 145 is used to decode the MPEG4 signals for the sink 130. The sink device 130 is effectively upgraded to also decode the MPEG4 encoded services. This provides costs savings and ease of use. The system is distributed and the older equipment (e.g., decoder 135) is kept and new functionality (e.g. MPEG4 decoding) is added incrementally as needed, yet system control is unified and transparently provides the new services (e.g., MPEG4 decoding).

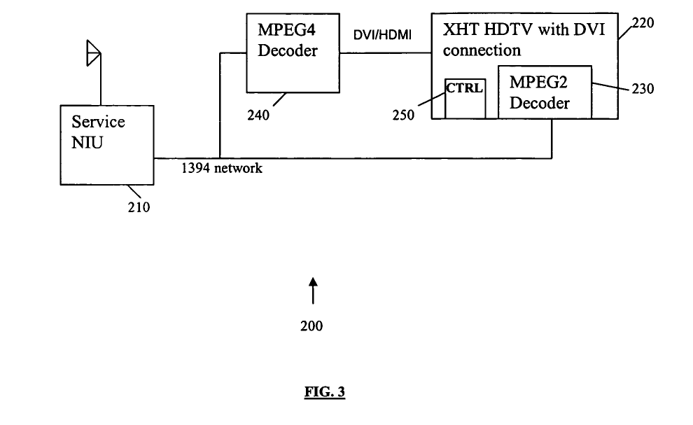

FIG. 3 shows another example embodiment of a network 200 according to the present invention, utilizing the IEEE 1394 network protocol, comprising a network interface unit (NIU) 210 as a source of digital satellite services that provides MEPG2 and MPEG4 coded signals, an HDTV 220 that includes an MPEG2 decoder 230 for decoding the MPEG2 coded signal from the NIU, and an MPEG4 decoder 240 that has been connected to the DVI port of the HDTV 220 to decode the MPEG4 signals from the NIU 210.

The 1394 network digital interface is used to connect the NIU 210 to the HDTV 220. The interface provides digital signals in a manageable compressed form and can include digital networking protocols that allow components to communicate back and forth to simplify the operation of the entire network with minimum commands from users.

The HDTV 220 includes a digital video interface (DVI) port to which the MPEG4 decoder 240 is attached. DVI is a digital port designed to relay uncompressed digital signals from the NIU 210 to the HDTV 220 for display. An enhanced form of DVI is high definition multimedia interface (HDMI) used between any audio/video source, such as a set-top box, DVD player, or A/V receiver, and an audio or video monitor, such as a HDTV. HDMI supports standard, enhanced or high-definition video, and multi-channel digital audio on a single cable. An advantage of HDMI is that when the individual devices are enabled, a single remote control can operate devices in a home network. HDMI covers the conversion of video formats such that signals on a PC can be properly relayed for display on a TV monitor, for example. As such, the HDTV 220 can include an HDMI port to which the MPEG4 decoder 240 is connected.

The MPEG4 decoder 240 has been added to provide new service user interface for the MPEG4 signal from the NIU 210, as if the MPEG4 decoder 240 were internally placed and connected to the HDTV 220. Because the MPEG2 system level transport is the same or similar to MPEG4, the NIU 210 remains the same device that delivers MPEG2 services, and now also delivers MPEG4 services.

The switching between the external MPEG4 decoder 240 and the internal MPEG2 decoder 230 (based on the type of signal to be decoded) is handled transparently by matching device capabilities from the NIU source 210 to proper decoder (decoder 230 or decoder 240) in a network connection manager built into the HDTV 220. This allows incrementally improving functionality of the HDTV 220 rather than replacing the HDTV 220 with another HDTV that provides both MPEG2 and MPEG4 decoding. Other embodiments include other decoder types (known to those skilled in the art) and entirely other services (known to those skilled in the art) provided to the HDTV 220.

In this example, the HDTV 220 utilizes the XHT protocol (XHTML 1.0 The Extensible HyperText Markup Language) to transparently add features to the HDTV 220. The HDTV 220 includes a controller 250 that performs the switching by sending the MPEG4 signals to the MPEG4 decoder 240 that is attached to the DVI port (e.g., HDMI port) of the HDTV 220 for decoding. The XHT protocol services the user interface for the MPEG4 decoder 240 as necessary.

In an example, a DSS signal is sent to the HDTV 220 via the 1394 network for display. If the DSS signal is in MPEG2 format, then the MPEG2 signal is sent to the MPEG2 decoder 230 in the HDTV 1394 network for decoding the MPEG2 encoded signal and display by the HDTV 220. However, if the DSS signal is in MPEG4 format, then that signal is sent to the MPEG4 decoder 240 over the 1394 network to the MPEG4 decoder 240 for decoding, wherein the decoded signal is provided from the MPEG4 decoder to the HDTV 220 for display via the DVI port of the HDTV 220.

The DVI (or HDMI) input of the HDTV 220 allows adding additional processing devices to the HDTV 220 via the DVI port, wherein the controller 250 in the HDTV 200 is informed of the new processing. The controller 250 in the HDTV 220 can selectively switch (route) source signals from the NIU 210 to the MPEG4 decoder 240 for decoding, wherein the decoded signal is provided to the HDTV 220 by the MPEG4 decoder 240 via the DVI port of the HDTV 220. In one embodiment, the controller 250 includes a receiver that determines the type of source signals, and a selector that selects between the decoder 230 and 240 depending on the type of the source signal, and also switches the HDTV 220 to receive decoded signals from one of the selected decoders 230 or 240.

In this example, recognition of a signal from the NIU 210 as being in a new (e.g., MPEG4) format and the switching to send it to the MPEG4 decoder 240, is built into the controller 250 in the HDTV 220. Alternatively, such recognition and switching can be built into the MPEG4 decoder 240. Further, the recognition and switching can also implemented in the NIU 210 as the NIU 210 is aware of the type of signal (e.g., MPEG2, MPEG4, etc.) and can send the MPEG4 signal to the MPEG4 decoder 240 for decoding.

The switching of the HDTV 220 to receive decoded signals from the MPEG2 decoder 230 or the MPEG4 decoder 240, can be performed by the NIU 210 through a connection to switch the signal input to the HDTV from the 1394 network input to the DVI port of the HDTV 220 (preferably, transparent to the user of a HDTV 220).

Because the service NIU 210 is usually the device that provides the Electronic Program Guide (EPG) Data and tracks the correspondence between the data stream Program Identifiers (PIDs) for Audio and Video and the actual service channel (e.g., CNN Headline News), the NIU 210 has easy access to the data that indicates how the data channels are compressed (e.g., MPEG2, MPEG4, etc.). The NIU 210 can switch the HDTV 220 between the output of the MPEG4 decoder 240, and the output of the MPEG2 decoder 230 internal to the HDTV 220 using the CEA-931-B Select A/V Input Function command with the proper 1-byte argument that is established at setup time. The argument of that command is an unsigned byte value in the range 0 to 255. The exact values that the NIU 210 should use is a function of how the output of the MPEG4 decoder 240 is connected to the HDTV 220. Usually this will be either by DVI or by (Y, Pr, Pb). A one time dialog will generally be required at setup to establish the proper switching values. Subsequently, the switching happens automatically and will be transparent to the user.

Alternatively, the switching of the HDTV 220 can be performed by the MPEG4 decoder 240 or by the HDTV controller 250. Where the recognition and switching is performed by the MPEG4 decoder 240, in addition to decoding capabilities, such a decoder includes networking protocol capabilities, signal recognition and automatic TV switching.

The recognition and switching can be implemented e.g. in software or firmware as an XHT recognition application that is running in either the NIU 210, the new decoder 240 or the controller 250, in the XHT network depending on implementation. An application that would perform a control function from one device to another using CEA-931-B HTTP commands is described in the CEA-2027 and CEA-931-B specifications (known by those skilled in the art). The XHT controller is capable of appearing as an overlay on top of both DVI sourced video and 1394 sourced video and generally independent from the video source. Preferably, the XHT on-screen display is capable of overlay and alpha blocking over the DVI/HDMI input video of the HDTV 220.

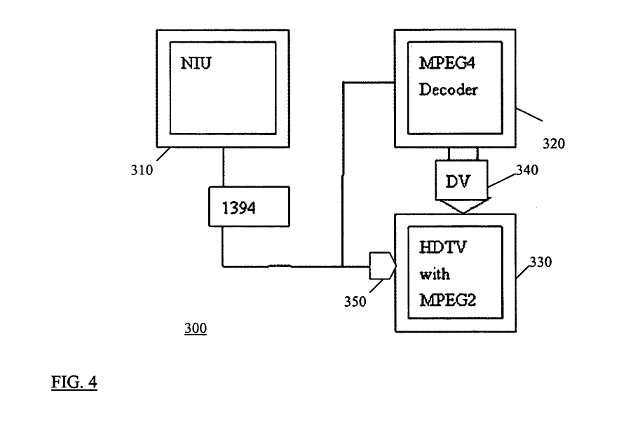

FIG. 4 shows an example function block diagram of another embodiment of a network 300 according to the present invention which allows incremental addition of functions, illustrating an example connectivity diagram for an NIU 310, an MPEG4 decoder 320 and HDTV 330 (including an MPEG2 decoder not shown) on a 1394 network. The MPEG4 decoder is incrementally added to the network 300, such that the output of the MPEG4 decoder 320 is connected to a DVI input port 340 of the HDTV 330.

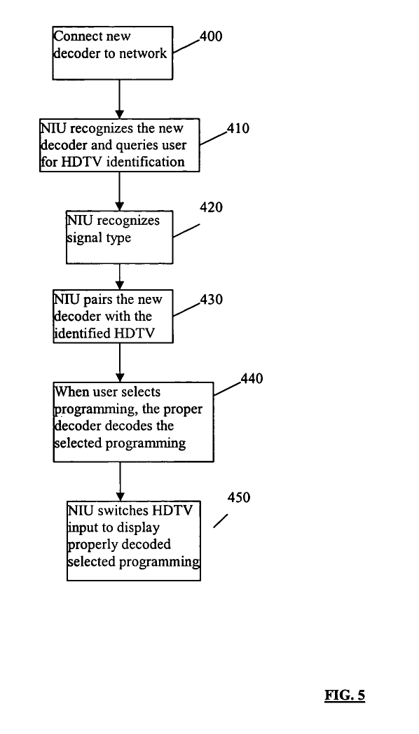

Referring to the example flowchart in FIG. 5, an example configuration and operation of the network 300 in FIG. 4 is now described. The new MPEG decoder 320 is added to the network 300 which initially included the NIU 310 and the HDTV 330 (with internal MPEG2 decoder) (step 400). The NIU 310 recognizes addition of the new MPEG4 decoder 320 on the network 300, wherein the NIU 310 queries the user for information on identification of the HDTV 330 to which the MPEG4 decoder 320 is newly connected (step 410). Then, the NIU 310 recognizes the type of signal compression applied to the source video (i.e., MPEG2, MPEG4, etc.) (step 420).

The NIU then performs pairing the operation of the MPEG4 decoder 320 with the HDTV 330 (step 430). Note that in the case of FIG. 4 where one MPEG4 decoder and one HDTV with an internal MPEG2 decoder is shown, the pairing of the HDTV and the MPEG decoder may be assumed. However, in the example shown in FIG. 2, where the network includes at least two external MPEG decoders 145, 146 and two sink devices 130, 131, then the pairing of the HDTVs and the external MPEG4 decoders may be performed by the NIU.

Referring back to FIGS. 4-5, after pairing of the HDTV 330 and the MPEG4 decoder 320, when the user selects programming services to view from the NIU 310, the HDTV 330 can display either MPEG2 programs decoded internally (by the internal MPEG2 decoder), or display MPEG4 programs decoded externally by the added MPEG4 decoder 320 and viewed through the DVI port 340 (or equivalent) (step 440). The switching of the HDTV input may be performed automatically by the NIU 310 via e.g. the “Select A/V Input Function” command as defined in CEA 931B specification (known by those skilled in the art), to select the 1394 input 350 (for MPEG2 signals) or DVI input 340 (for MPEG4 signals) of the HDTV 330 (step 450).

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures above according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of incrementally adding functions to a network including a source device and a sink device, wherein the source device provides signals to the sink device, the method comprising the steps of:
(a) determining the type of a source signal from the source device;
(b) determining if the sink device is capable of properly utilizing the source signal; and
(c) if the sink device is not capable of utilizing the source signal, then providing a function in the network which enables the sink device to properly utilize the source signal.

2. The method of claim 1, further including the steps of switching the sink device to utilize said function.

3. The method of claim 2, wherein the step of providing said function in the network further includes the steps of providing a processing device in the network that enables the sink device to properly utilize the source signal.

4. The method of claim 1, wherein the source signal comprises a video signal.

5. The method of claim 1, wherein:
the source device provides encoded signals to the sink device;
in step (a) determining the type of the source signal further includes the steps of determining the type of encoding of the source signal;
in step (b) determining if the sink device is capable of utilizing the source signal further includes the steps of determining if the sink device can decode the source signal; and
in step (c) providing said function in the network further includes the steps of providing a decoder in the network for decoding the source signal for the sink device.

6. The method of claim 5, further comprising the steps of:
(d) switching the source device to utilize the signal decoded by the decoder.

7. The method of claim 5, wherein the source device comprises a video signal source device and the sink device comprises a video signal sink device.

8. The method of claim 7, wherein the video signal sink device comprises a television monitor.

9. The method of claim 7, wherein then network comprises a 1394 network.

10. The method of claim 7, wherein the step of adding the decoder in the network further includes connection the decoder to a DVI input of the sink device for the sink device to receive the signal decoded by the decoder.

11. The method of claim 7, wherein the sink device implement an XHTML protocol.

12. A network, comprising:
a source device;
a sink device, wherein the source device provides signals to the sink device; and
a controller that determines the type of a source signal from the source device, such that if the sink device is not capable of properly utilizing the source signal, the controller provides a function in the network that enables the sink device to properly utilize the source signal;
such that functions can incrementally be added to the network.

13. The network of claim 12, further comprising a processing device in the network that can function to enable the sink device to properly utilize the source signal, wherein the controller further controls the processing device to provide said function to enable the sink device to properly utilize the source signal.

14. The network of claim 12, wherein the controller further switches the sink device to utilize said function.

15. The network of claim 12, wherein the source signal comprises a video signal.

16. The network of claim 12, wherein:
the source device provides encoded signals to the sink device;
the controller further determines the type of encoding of the source signal, such that if the sink device is not capable of decoding the source signal, the controller controls the processing device to decode the source signal for the sink device.

17. The network of claim 16, wherein the controller further switches the source device to utilize the signal decoded by the processing device.

18. The network of claim 16, wherein the source device comprises a video signal source device and the sink device comprises a video signal sink device.

19. The network of claim 18, wherein the video signal sink device comprises a television monitor.

20. The network of claim 18, wherein then network comprises a 1394 network.

21. The network of claim 18, wherein the processing device is connected to a DVI input of the sink device for the sink device to receive the signal decoded by the processing device.

22. The network of claim 18, wherein the controller an XHTML protocol.

23. A controller for a network that includes a source device and a sink device, wherein the source device provides signals to the sink device, the controller comprising:
a receiver that determines the type of a source signal from the source device; and
a selector, such that if the sink device is not capable of properly utilizing the source signal, the selector selects and provides a function in the network that enables the sink device to properly utilize the source signal;
such that functions can incrementally be added to the network.

24. The controller of claim 23, wherein the network further included a processing device that can function to enable the sink device to properly utilize the source signal, wherein the selector further controls the processing device to provide said function to enable the sink device to properly utilize the source signal.

25. The controller of claim 23, wherein the selector further switches the sink device to utilize said function.

26. The controller of claim 23, wherein the source signal comprises a video signal.

27. The controller of claim 23, wherein:
the source device provides encoded signals to the sink device;
the receiver further determines the type of encoding of the source signal, such that if the sink device is not capable of decoding the source signal, the selector controls the processing device to decode the source signal for the sink device.

28. The controller of claim 27, wherein the selector further switches the source device to utilize the signal decoded by the processing device.

29. The controller of claim 28, wherein the source device comprises a video signal source device and the sink device comprises a video signal sink device.

30. The controller of claim 29, wherein the video signal sink device comprises a television monitor.

31. The controller of claim 29, wherein then network comprises a 1394 network.

32. The controller of claim 29, wherein the processing device is connected to an input of the sink device for the sink device to receive the signal decoded by the processing device.

33. The controller of claim 29, wherein the processing device is connected to a DVI input of the sink device for the sink device to receive the signal decoded by the processing device.
